(19) United States
(12) Patent Application Publication
(10) Pub. No.: US 2022/0114646 A1
(43) Pub. Date: Apr. 14, 2022

(54) INFORMATION PROCESSING DEVICE, INFORMATION PROCESSING METHOD, AND PROGRAM

(71) Applicant: TOYOTA JIDOSHA KABUSHIKI KAISHA, Toyota-shi (JP)

(72) Inventors: Toyokazu NAKASHIMA, Nagoya-shi (JP); Takayuki HATORI, Nagakute-shi (JP); Shuichi SAWADA, Nagoya-shi (JP); Daiki KUBO, Toyota-shi (JP); Tomoki ISHIKAWA, Nagoya-shi (JP); Naoya OKA, Nagakute-shi (JP)

(73) Assignee: TOYOTA JIDOSHA KABUSHIKI KAISHA, Toyota-shi (JP)

(21) Appl. No.: 17/462,732

(22) Filed: Aug. 31, 2021

(30) Foreign Application Priority Data
Oct. 14, 2020 (JP) 2020-173111

(51) Int. Cl. G06Q 30/06

(52) U.S. Cl. CPC G06Q 30/0633; G06Q 30/0613; G06Q 30/0631

(57) ABSTRACT

An information processing device includes a control unit that executes acquisition of information relating to a sound emitted around a user, and estimation of a product consumed by the user and a consumption quantity of the product based on the information relating to the sound.

### CROSS-REFERENCE TO RELATED APPLICATION

This application claims priority to Japanese Patent Application No. 2020-173111 filed on Oct. 14, 2020, incorporated herein by reference in its entirety.

### BACKGROUND

### 1. Technical Field

The present disclosure relates to an information processing device, an information processing method, and a program.

### 2. Description of Related Art

A technique for supporting periodical purchase of goods, such as daily necessities, is known. For example, Japanese Unexamined Patent Application Publication No. 2016-224650 (JP 2016-224650 A) discloses a system that executes a process of ordering a product related to a beacon device that is triggered by pressing an order button provided for the beacon device. Installation of the beacon device described in JP 2016-224650 A in the vicinity of a place where products are stored, such as a refrigerator or a washroom, makes it possible to order products with a simple operation.

### SUMMARY

On the other hand, in the prior art, there is room for improvement in that a user has to manage the inventory of the products and place an order by the user. An object of the present disclosure is to estimate a consumption quantity of the product.

An aspect of the present disclosure provides an information processing device including a control unit that executes: acquisition of information relating to a sound emitted around a user; and estimation of a product consumed by the user and a consumption quantity of the product based on the information relating to the sound.

An aspect of the present disclosure provides an information processing method including: acquiring information relating to a sound emitted around a user by a computer; and estimating a product consumed by the user and a consumption quantity of the product by the computer based on the information relating to the sound.

An aspect of the present disclosure provides a program that causes a computer to execute: acquisition of information relating to a sound emitted around a user; and estimation of a product consumed by the user and a consumption quantity of the product based on the information relating to the sound.

Another aspect of the present disclosure is a computer-readable storage medium that non-transitorily stores the above program.

According to the present disclosure, the consumption quantity of the product can be estimated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a system according to a first embodiment;

FIG. 2 is a block diagram schematically showing an example of the configurations of a user terminal and a server constituting the system according to the first embodiment;

FIG. 3 is a diagram illustrating a functional configuration of the user terminal;

FIG. 4 is a diagram illustrating a configuration of a product information table stored in a product database (DB);

FIG. 5 is a flowchart showing a flow of a process of ordering a product by the user terminal;

FIG. 6 is a diagram illustrating a configuration of a product information table stored in a product DB according to a second embodiment; and

FIG. 7 is a flowchart showing a flow of the process of ordering the product by the user terminal.

### DETAILED DESCRIPTION OF EMBODIMENTS

An information processing device that is one of the aspects of the present disclosure includes a control unit. The control unit acquires information relating to a sound emitted around a user, and estimates a product consumed by the user and a consumption quantity of the product based on the information relating to the sound. The information relating to the sound emitted around the user is information relating to a sound generated when the user consumes the product. The sound may be a sound generated from the user or the product, or may be a sound generated from the periphery of the user or the product with the use of the product.

The sound generated when the product is consumed may include, for example, a sound of preparing to consume the product, a sound during consumption of the product, and a sound generated after the product is consumed. The sound generated when the product is consumed includes, for example, a sound of opening a beer can and a sound of crushing the beer can after the user finishes drinking the beer. The sound generated when the product is consumed also includes a sound of crushing a tissue paper box when tissue papers are used up. Here, with the beer can as an example, the shape, thickness, material, coating, or size of the can differ depending on the brand of beer. Therefore, the sound when a can is crushed can be unique to the brand. In addition, the shape, thickness, material, coating, size, carbonic acid concentration, shape of an opening (lip), or content of the can differ depending on the brand of beer. Therefore, the sound when the beer can is opened can be unique to the brand. Therefore, for example, it is possible to determine which brand of beer is consumed based on the sound when the beer can is crushed or the sound when the beer can is opened. This is not limited to the beer cans. The cans of other beverages can be similarly identified.

As described above, the consumed product can be estimated if a unique sound is detected when the product is consumed. Further, the number of times the product is consumed correlates with the consumption quantity of the product. Therefore, the consumption quantity of the product can be estimated by counting the number of times the product is consumed, for example. The information relating to the sound can be acquired from, for example, a smart speaker installed at home of the user or in a smartphone of the user. As described above, it is possible to estimate the product consumed by the user and the consumption quantity of the product based on the information relating to the sound around the user.

Hereinafter, embodiments of the present disclosure will be described with reference to the drawings. The configurations of the following embodiments are illustrative, and the present disclosure is not limited to the configurations of the embodiments. Further, the following embodiments can be combined as much as possible.

### First Embodiment

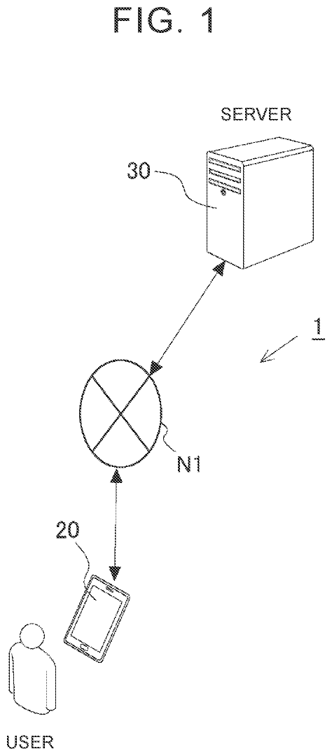

FIG. 1 is a diagram showing a schematic configuration of a system 1 according to a first embodiment. The system 1 includes a user terminal 20 and a server 30. The user terminal 20 and the server 30 are connected to each other by a network N1.

The network N1 is, for example, a world-wide public communication network such as the Internet, and a wide area network (WAN) or other communication networks may be adopted. In addition, the network N1 may include a telephone communication network such as a mobile phone network or a wireless communication network such as Wi-Fi (registered trademark). Note that FIG. 1 illustrates one user terminal 20 and one server 30 by way of example. However, there may be a plurality of the user terminals 20 and a plurality of the servers 30.

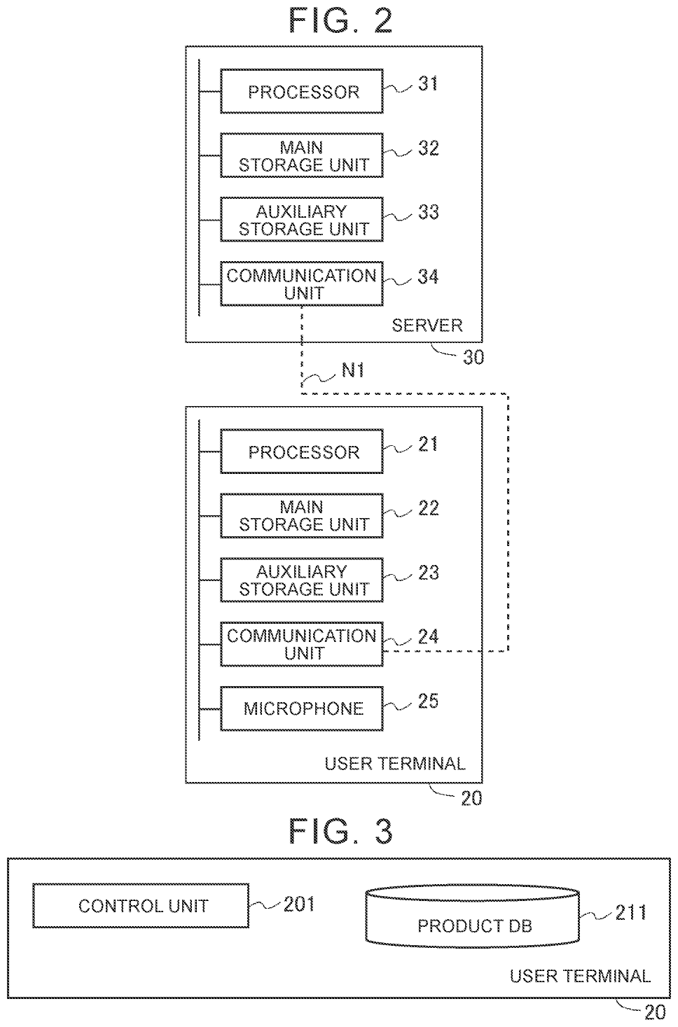

The hardware configurations of the user terminal 20 and the server 30 will be described with reference to FIG. 2. FIG. 2 is a block diagram schematically showing an example of the configurations of the user terminal 20 and the server 30 constituting the system 1 according to the present embodiment.

The server 30 is a computer that conducts electronic commerce, and trades products with the user terminal 20. The server 30 has a general computer configuration. The server 30 executes a process of receiving an order for a product from the user terminal 20, and executes a process of providing the ordered product to the user. The server 30 executes a process of notifying, for example, a distribution center, of a name of the product to be delivered and a delivery destination. Existing means such as a home delivery service can be used for actual delivery. Therefore, the description thereof will be omitted. The server 30 includes a processor 31, a main storage unit 32, an auxiliary storage unit 33, and a communication unit 34. The components above are connected to each other by a bus.

The processor 31 is a central processing unit (CPU), a digital signal processor (DSP), or the like. The processor 31 controls the server 30 and performs various information processing calculations. The main storage unit 32 is a random access memory (RAM), a read-only memory (ROM), or the like. The auxiliary storage unit 33 is an erasable programmable ROM (EPROM), a hard disk drive (HDD), a removable medium, or the like. The auxiliary storage unit 33 stores an operating system (OS), various kinds of programs, various kinds of tables, and the like. The processor 31 loads the program stored in the auxiliary storage unit 33 into the work area of the main storage unit 32 and executes the program. Through execution of the program, each component is controlled. As a result, the server 30 realizes the function that matches the predetermined purpose. The main storage unit 32 and the auxiliary storage unit 33 are computer-readable recording media. The server 30 may be a single computer or may include a plurality of computers linked together. Further, the information stored in the auxiliary storage unit 33 may be stored in the main storage unit 32. Further, the information stored in the main storage unit 32 may be stored in the auxiliary storage unit 33.

The communication unit 34 is means for communicating with the user terminal 20 via the network N1. The communication unit 34 is, for example, a local area network (LAN) interface board or a wireless communication circuit for wireless communication. The LAN interface board and the wireless communication circuit are connected to the network N1.

Next, the user terminal 20 is a small computer such as a smartphone, a smart speaker, a mobile phone, a tablet terminal, a personal information terminal, a wearable computer (smart watch, for example), or a personal computer (PC). The user terminal 20 includes a processor 21, a main storage unit 22, an auxiliary storage unit 23, a communication unit 24, and a microphone 25. The components above are connected to each other by a bus. The processor 21, the main storage unit 22, and the auxiliary storage unit 23 of the user terminal 20 are similar to the processor 31, the main storage unit 32, and the auxiliary storage unit 33 of the server 30, respectively, and thus the description thereof will be omitted.

The communication unit 24 is communication means for connecting the user terminal 20 to the network N1. The communication unit 24 is a circuit for communicating with other devices (for example, the server 30) via the network N1 using wireless communication such as a mobile communication service (for example, a telephone communication network such as the fifth generation (5G), the fourth generation (4G), the third generation (3G), and long term evolution (LTE)), Wi-Fi (registered trademark), Bluetooth (registered trademark), or radio frequency identification (RFID). The microphone 25 is a device that acquires a sound and converts the sound into an electric signal.

Next, functions of the user terminal 20 will be described. FIG. 3 is a diagram illustrating a functional configuration of the user terminal 20. The server 30 includes a control unit 201 and a product database (DB) 211 as functional components. The processor 21 of the user terminal 20 executes the process of the control unit 201 using a computer program stored in the main storage unit 22. However, a part of the control unit 201 may be executed by a hardware circuit.

The product DB 211 is constructed in a manner such that a program of a database management system (DBMS) executed by the processor 21 manages data stored in the auxiliary storage unit 23. The product DB 211 is, for example, a relational database.

The control unit 201 estimates a consumed product and a consumption quantity of the product based on the sound acquired by the microphone 25. The product estimated to be consumed may be limited to a product registered by the user in advance, or may be limited to a product that can be shipped by the server 30. When the remaining quantity of the product reaches or falls below the lower limit, or when the consumption quantity of the product reaches or falls below the upper limit, the product is ordered. The relationship between the sound acquired by the microphone 25 and the consumed product is stored in the product DB 211. When the product is ordered, the control unit 201 transmits, to the server 30, information relating to the product, information relating to an order quantity, and information relating to a shipping address.

The information relating to the product to be transmitted to the server 30 is information that can identify the product, for example, a product name or a product identification (ID). The information relating to the order quantity to be transmitted to the server 30 is information relating to the quantity of the product to be ordered at one time. The order quantity may be set by the user, or the consumption quantity of the product may be set as the order quantity. The information relating to the shipping address to be transmitted to the server 30 is information required for delivering the product to the user. The information relating to the shipping address includes, for example, information relating to the address, name, and telephone number of the user.

When one product is consumed, the control unit 201 adds one to a consumption counter. The consumption counter is a counter that counts the number of times the product is consumed. The consumption counter is set for each product. As described above, the control unit 201 counts the consumption quantity of the product. When the consumption counter reaches or exceeds a predetermined value, the control unit 201 orders the product with the server 30. The predetermined value may be set based on the remaining quantity of the product. For example, the predetermined value may be set such that the product arrives before the remaining quantity of the product becomes zero. In this case, for example, the user registers the initial value of an inventory quantity of the product in the user terminal 20. The number of products to be ordered may be, for example, the same as the number indicated by the consumption counter. Therefore, the predetermined value that is a threshold for ordering the product with the server 30 may be set to an integral multiple of the sales unit of the product.

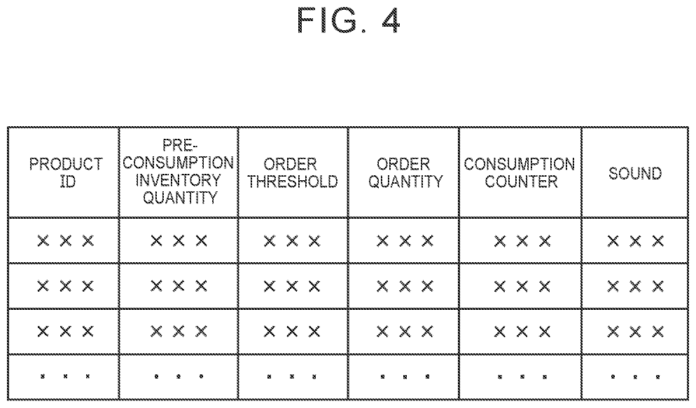

FIG. 4 is a diagram illustrating the configuration of a product information table stored in the product DB 211. The product information table includes fields of product ID, pre-consumption inventory quantity, order threshold, order quantity, consumption counter, and sound. The product ID field is a field in which identification information (product ID) corresponding to each product is input. The product ID may be transmitted from the server 30. The pre-consumption inventory quantity field is a field in which the remaining quantity of the product before the user consumes the product is input. The user inputs the initial value of the pre-consumption inventory quantity to the user terminal 20. The order threshold field is a field in which the remaining quantity of the product is input. The remaining quantity of the product serves as a threshold (order threshold) for ordering the product by the control unit 201.

The order threshold may be set by the user, or may be set by the control unit 201 or the server 30. The order quantity field is a field in which the quantity (order quantity) of the product to be ordered at one time is input. The order quantity may also be set by the user, or may be set by the control unit 201 or the server 30. Further, the order quantity may be the same as the number indicated by the consumption counter. The consumption counter field is a field in which the numerical value of the consumption counter is input. The control unit 201 estimates the consumed product based on the sound acquired by the microphone 25, and updates the consumption counter field corresponding to the product.

The sound field is a field in which information relating to the sound when the product is consumed is input, or a field in which information indicating a location where the information relating to the sound when the product is consumed is stored is input. The information relating to the sound is acquired from, for example, the server 30. The information relating to the sound may be a feature value of the sound.

For example, a sound of crushing a can or a container, a sound of crushing the outer box of a product, or a sound of opening a can or a container are related to consumption of the product. Therefore, the sounds may be learned in advance for respective products and stored in the server 30. For example, when the user inputs the product and its inventory quantity to the user terminal 20, the control unit 201 requests the server 30 to transmit the information relating to the sound when the product is consumed. The server 30 stores the feature value of the sound when the product is consumed for each product. The relationship between the product and the feature value of the sound is obtained in advance by, for example, an experiment or a simulation, and is stored in the auxiliary storage unit 33 of the server 30.

The control unit 201 calculates a value obtained by subtracting the order threshold from the pre-consumption inventory quantity as the consumption quantity with which an order placement for the product is required. When the consumption counter reaches or exceeds the consumption quantity with which the order placement is required, the order is placed with the server 30 in accordance with the order quantity. At this time, the control unit 201 transmits, to the server 30, the product ID, the order quantity, and the shipping address. When the order placement is completed, the control unit 201 updates the pre-consumption inventory quantity by inputting the total value obtained by adding the value of the consumption counter to the order threshold to the pre-consumption inventory quantity. After that, the control unit 201 resets the consumption counter.

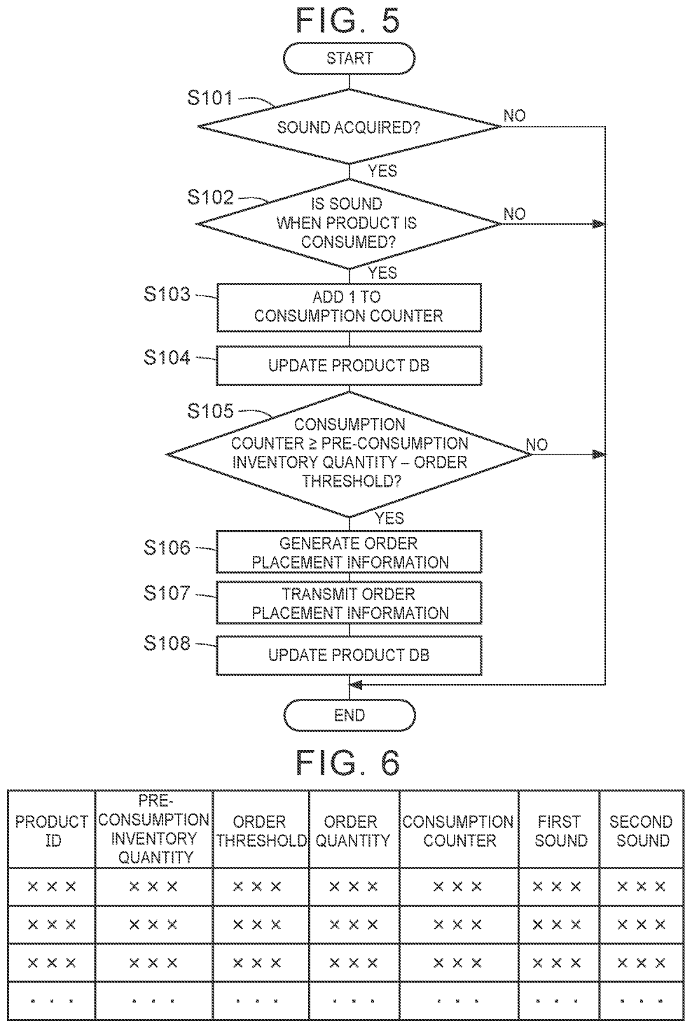

Next, the process of ordering the product by the user terminal 20 will be described. FIG. 5 is a flowchart showing a flow of the process of ordering the product by the user terminal 20. The flowchart shown in FIG. 5 is executed by each user terminal 20 at predetermined time intervals. The description will be made on assumption that, in the product information table, necessary information is already stored in each of the product ID field, the pre-consumption inventory quantity field, the order threshold field, the order quantity field, and the sound field. Further, the description will also be made on assumption that the shipping address of the product is stored in the auxiliary storage unit 23 of the user terminal 20.

In step S101, the control unit 201 determines whether the sound is acquired by the microphone 25. When an affirmative determination is made in step S101, the process proceeds to step S102, and when a negative determination is made, the routine is terminated. In step S102, the control unit 201 determines whether the sound acquired in step S101 corresponds to the sound when the product is consumed. For example, the control unit 201 extracts the feature value of the sound acquired by the microphone 25, compares the extracted feature value with the feature value of the sound indicated in the sound field of the product DB 211, and searches for a matching product. When there is a matching product, the control unit 201 determines that the acquired sound is the sound when the product is consumed. When an affirmative determination is made in step S102, the process proceeds to step S103, and when a negative determination is made, the routine is terminated.

In step S103, the control unit 201 counts up the consumption counter by adding one to the consumption counter. With the process above, the number of times the product is consumed, that is, the consumption quantity of the product, is counted. In step S104, the control unit 201 updates the product DB 211 by storing the consumption counter calculated in step S103 in the product DB 211.

In step S105, the control unit 201 determines whether the consumption counter is equal to or greater than the value obtained by subtracting the order threshold from the pre-consumption inventory quantity. That is, the control unit 201 determines whether the consumption quantity of the product corresponding to the sound acquired in step S101 has reached the number of times at which the order placement for the product is required. When an affirmative determination is made in step S105, the process proceeds to step S106, and when a negative determination is made, the routine is terminated.

In step S106, the control unit 201 generates order placement information. The order placement information is information required for delivering the product to the user, and is information transmitted by the control unit 201 to the server 30. The order placement information includes information relating to the product ID, the order quantity of the product, and the information relating to the shipping address of the product. The control unit 201 generates the order placement information based on the information stored in the auxiliary storage unit 23. In step S107, the control unit 201 transmits the order placement information to the server 30. Subsequently, in step S108, the control unit 201 updates the product DB 211. At this time, the control unit 201 resets the consumption counter, and further, inputs the total value obtained by adding the value of consumption counter to the order threshold to the pre-consumption inventory quantity.

As described above, according to the first embodiment, the user terminal 20 can acquire the sound around the user, estimate the consumed product based on the sound, and estimate the consumption quantity of the product. Furthermore, the product can be ordered in accordance with the consumption quantity of the product. Therefore, the user can replenish the product at an appropriate time without management of the inventory of the product by the user.

### Second Embodiment

FIG. 6 is a diagram illustrating the configuration of the product information table stored in a product DB 211A according to a second embodiment. The product information table includes fields of product ID, pre-consumption inventory quantity, order threshold, order quantity, consumption counter, and first sound, and second sound. The product ID, the pre-consumption inventory quantity, the order threshold, the order quantity, and the consumption counter are the same as those in FIG. 4 according to the first embodiment, and thus description thereof will be omitted. Further, the first sound field corresponds to the sound field shown in FIG. 4 according to the first embodiment. Similar to the first sound field, the second sound field is a field in which the information relating to the sound when the product is consumed is input, or a field in which the information indicating a location where the information relating to the sound when the product is consumed is stored is input. The sounds in the first sound field and the second sound field are different sounds. For example, the sound input to the first sound field and the sound input to the second sound field may be sounds acquired at different time points. Further, in the second sound field, the information relating to the sound for improving the estimation accuracy of the product may be input.

Here, it is conceivable that the estimation accuracy of the product may be degraded only with the sound (the first sound) when the product is consumed. Therefore, the control unit 201 estimates the consumed product based on the second sound in addition to the first sound. The second sound is, for example, a sound acquired before or after the product is consumed. For example, when beer cans and alcohol-free carbonated beverages are distinguished from each other, the user is identified based on footsteps of the user heading to the refrigerator. When the user is a father, the control unit 201 determines that the beer is consumed, and when the user is a child, the control unit 201 determines that the alcohol-free carbonated beverage is consumed. Further, the consumed product can be estimated based on an utterance of the user such as “pass me a beer”. For example, when the utterance of the user includes a predetermined keyword, the control unit 201 estimates that the product corresponding to the keyword is consumed. The relationship between the predetermined keyword and the product may be input to the user terminal 20 by the user, or data learned in advance may be acquired from the server 30. Also, for example, the consumed product may be estimated based on the sound of pouring the beverage. The sound of pouring the beverage is also considered to be unique to the brand. Therefore, the consumed product can be estimated based on the sound of pouring the beverage by obtaining the relationship between the product and the sound of pouring the beverage.

Also, for example, the consumed product may be estimated based on the relationship that water is consumed after the sound of a shower is emitted, white wine is consumed when the sound of roasting fish is emitted, and red wine is consumed after the sound of roasting meat is emitted. The relationship between the sounds above and the consumed products may be input by the user to the user terminal 20, or the user terminal 20 may learn the relationship between the product ordered by the user and the sound.

The control unit 201 may estimate the consumed product based on the second sound only when the product cannot be estimated based on the first sound, or estimate the consumed product based on both the first sound and the second sound. In addition, the control unit 201 may estimate the consumed product based on the second sound only. That is, the control unit 201 may estimate the consumed product based on either the first sound or the second sound.

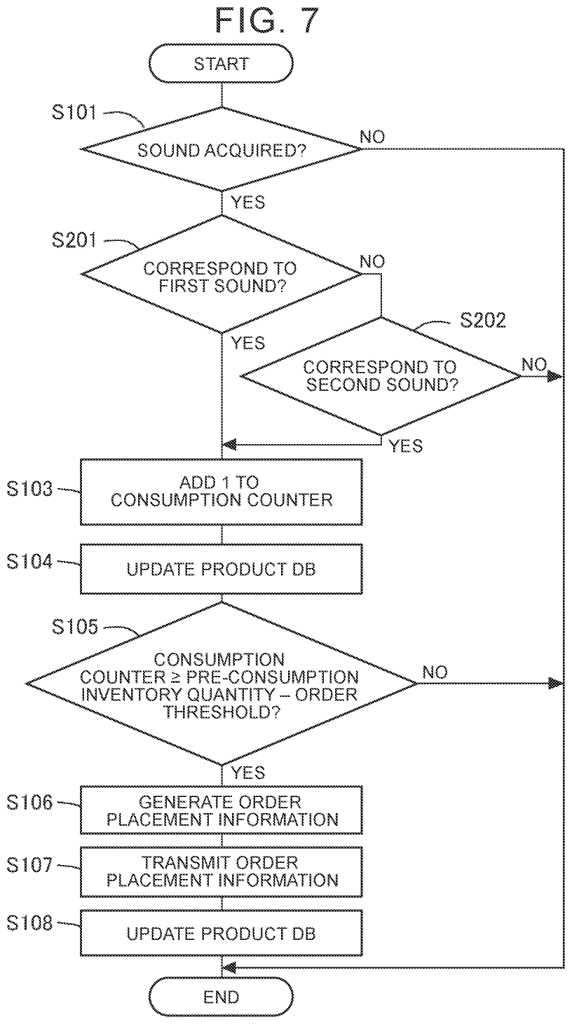

Next, the process of ordering the product by the user terminal 20 will be described. FIG. 7 is a flowchart showing a flow of the process of ordering the product by the user terminal 20. The flowchart shown in FIG. 7 is executed by each user terminal 20 at predetermined time intervals. The steps in which the same processes as those in the routine shown in FIG. 5 are executed are designated by the same reference signs, and the description thereof will be omitted. In the routine shown in FIG. 7, when a sound corresponding to either the first sound or the second sound is acquired, the control unit 201 estimates that the product corresponding to the acquired first sound or second sound is consumed.

In the routine shown in FIG. 7, when an affirmative determination is made in step S101, the process proceeds to step S201. In step S201, the control unit 201 determines whether the sound acquired in step S101 corresponds to the first sound. For example, the control unit 201 extracts the feature value of the sound acquired by the microphone 25, compares the extracted feature value with the feature value of the sound stored in the first sound field of the product DB 211A, and searches for a matching product. When there is a matching product, the control unit 201 determines that the acquired sound corresponds to the first sound. When an affirmative determination is made in step S201, the process proceeds to step S103, and when a negative determination is made, the process proceeds to step S202.

In step S202, the control unit 201 determines whether the sound acquired in step S101 corresponds to the second sound. The control unit 201 extracts the feature value of the sound acquired by the microphone 25, compares the extracted feature value with the feature value of the sound stored in the second sound field of the product DB 211A, and searches for a matching product. When there is a matching product, the control unit 201 determines that the acquired sound corresponds to the second sound. When an affirmative determination is made in step S201, the process proceeds to step S103, and when a negative determination is made, the routine is terminated.

As described above, when the sound matching either the first sound or the second sound is acquired, the consumed product can be specified. With the configuration above, the estimation accuracy can be improved by estimating the consumed products based on the sounds of different times.

### OTHER EMBODIMENTS

The above-described embodiment is merely an example, and the present disclosure may be appropriately modified and implemented without departing from the scope thereof.

The processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function. For example, the server 30 may be divided into a server that estimates the consumed product and a server that ships the product.

Further, the consumed product may be estimated by further considering the time when the sound is acquired. For example, when the sound of opening a can of carbonated drink is acquired in the middle of the night, it can be presumed that a beer can for adults to drink is opened instead of a can of carbonated drink for children. The relationship between the timeframe and the product to be consumed is stored in advance in the auxiliary storage unit 23.

Further, in the above embodiment, the number of times the sound of consuming the product is acquired is counted as the consumption quantity of the product. On the other hand, there are some products that cannot be consumed in one time of usage. For example, a single use of a lighter does not entirely consume as or oil in the lighter. Therefore, for example, a consumption amount of gas or oil may be estimated based on the lighting time of the lighter and the intensity of the fire. There is a correlation between the sound of the lighter when the lighter is lit and the amount of gas or oil consumed per unit time. Therefore, the consumption amount of gas or oil can be estimated by obtaining the correlation above in advance. Subsequently, the control unit 201 orders gas or oil when the consumption amount of gas or oil reaches or exceeds a predetermined amount.

The present disclosure can also be implemented by supplying a computer with a computer program that implements the functions described in the above embodiments, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc read-only memory (CD-ROM), digital versatile disc (DVD), Blu-ray disc, etc.), a read only memory (ROM), a random access memory (RAM), an erasable programmable read only memory (EPROM), an electrically erasable programmable read only memory (EEPROM), a magnetic card, a flash memory, an optical card, and any type of medium suitable for storing electronic commands.

What is claimed is:

1. An information processing device comprising a control unit that executes:
acquisition of information relating to a sound emitted around a user; and
estimation of a product consumed by the user and a consumption quantity of the product based on the information relating to the sound.

2. The information processing device according to claim 1, wherein the control unit acquires information relating to a sound acquired by a microphone provided around the user as the information relating to the sound.

3. The information processing device according to claim 1, wherein
the control unit:
acquires a feature value of the sound as the information relating to the sound; and
estimates the product consumed by the user by collating the feature value of the sound with stored data.

4. The information processing device according to claim 1, further comprising a storage unit that stores a relationship between the information relating to the sound and the product, wherein the control unit estimates the product consumed by the user based on the information relating to the sound and the relationship stored in the storage unit.

5. The information processing device according to claim 1, wherein the control unit estimates the consumption quantity of the product based on the number of times the user is estimated to have consumed the product.

6. The information processing device according to claim 1, wherein the control unit acquires information relating to a sound emitted around the user before or after the user consumes the product as the information relating to the sound.

7. The information processing device according to claim 1, wherein
the control unit:
counts the consumption quantity of the product;
calculates a remaining quantity of the product based on the counted consumption quantity of the product; and
orders the product when the calculated remaining quantity of the product is reduced to a threshold at which the product is ordered.

8. An information processing method, comprising:
acquiring information relating to a sound emitted around a user by a computer; and
estimating a product consumed by the user and a consumption quantity of the product by the computer based on the information relating to the sound.

9. The information processing method according to claim 8, wherein the computer acquires information relating to a sound acquired by a microphone provided around the user as the information relating to the sound.

10. The information processing method according to claim 8, wherein
the computer:
acquires a feature value of the sound as the information relating to the sound; and
estimates the product consumed by the user by collating the feature value of the sound with stored data.

11. The information processing method according to claim 8, wherein the computer estimates the product consumed by the user based on a relationship between the information relating to the sound and the product, the relationship being stored in a storage unit.

12. The information processing method according to claim 8, wherein the computer estimates the consumption quantity of the product based on the number of times the user is estimated to have consumed the product.

13. The information processing method according to claim 8, wherein the computer acquires information relating to a sound emitted around the user before or after the user consumes the product as the information relating to the sound.

14. The information processing method according to claim 8, wherein
the computer:
counts the consumption quantity of the product;
calculates a remaining quantity of the product based on the counted consumption quantity of the product; and
orders the product when the calculated remaining quantity of the product is reduced to a threshold at which the product is ordered.

15. A program that causes a computer to execute:
acquisition of information relating to a sound emitted around a user; and
estimation of a product consumed by the user and a consumption quantity of the product based on the information relating to the sound.

16. The program according to claim 15, wherein the computer is caused to acquire information relating to a sound acquired by a microphone provided around the user as the information relating to the sound.

17. The program according to claim 15, wherein the computer is caused to estimate the product consumed by the user based on a relationship between the information relating to the sound and the product, the relationship being stored in a storage unit.

18. The program according to claim 15, wherein the computer is caused to estimate the consumption quantity of the product based on the number of times the user is estimated to have consumed the product.

19. The program according to claim 15, wherein the computer is caused to acquire information relating to a sound emitted around the user before or after the user consumes the product as the information relating to the sound.

20. The program according to claim 15, wherein
the computer is caused to:
count the consumption quantity of the product;
calculate a remaining quantity of the product based on the counted consumption quantity of the product; and
order the product when the calculated remaining quantity of the product is reduced to a threshold at which the product is ordered.
